(19) United States
(12) Patent Application Publication
(10) Pub. No.: US 2024/0182680 A1
(43) Pub. Date: Jun. 6, 2024

(54) COMPOSITION COMPRISING AT LEAST ONE AROMATIC PEROXIDE AND AT LEAST ONE KETONE PEROXIDE

(71) Applicant: Arkema France, COLOMBES (FR)

(72) Inventors: Long CHEN, CHANGSHU (CN); Hui CHEN, CHANGSHU (CN); Bruno VAN HEMELRYCK, PIERRE-BENITE CEDEX (FR); Serge HUB, PIERRE-BENITE CEDEX (FR)

(21) Appl. No.: 18/285,720

(22) PCT Filed: Apr. 7, 2022
(86) PCT No.: PCT/EP2022/059329

§ 371 Date: Oct. 5, 2023

(30) Foreign Application Priority Data
Apr. 7, 2021 (FR) FR2103546
Apr. 7, 2021 (FR) FR2103548
Apr. 7, 2021 (FR) FR2103550

(51) Int. Cl. C08K 5/14

(52) U.S. Cl. CPC C08K 5/14

(57) ABSTRACT

Composition comprising at least one aromatic peroxide and at least one ketone peroxide The present invention deals with a composition comprising at least one aromatic peroxide comprising at least one aromatic ring and at least one peroxo function in its structure, as defined hereinafter, and at least one ketone peroxide.

### CROSS-REFERENCE TO RELATED APPLICATIONS

This application is a U.S. National Stage Application of International Patent Application No. PCT/EP2022/059329 filed on Apr. 7, 2022, which claims the benefit of French Patent Application No. FR2103546, filed on Apr. 7, 2021, French Patent Application No. FR2103548 filed on Apr. 7, 2021, and French Patent Application No. FR2103550 filed on Apr. 7, 2021.

### FIELD OF THE INVENTION

The present invention deals with a composition comprising at least one aromatic peroxide comprising at least one aromatic ring and at least one peroxo function in its structure, as defined hereinafter, and at least one ketone peroxide.

The invention also relates to the use of said composition in order to prepare a polymer, preferably styrenic polymers, or a polymer resin, in particular a polymer ester resin, said polymer ester resin being preferably chosen in the group consisting of unsaturated polyester resin, acrylic resin, methacrylic resin and vinyl ester resin.

The invention also pertains to the use of at least one ketone peroxide for improving the color stability of a composition comprising at least one aromatic peroxide having at least one aromatic ring and at least one peroxo function in its structure as defined hereinafter.

### BACKGROUND OF THE INVENTION

Aromatic peroxides are currently often used as radical initiators in various polymerization reactions, such as for the synthesis of styrenic resins, vinyl ester resins or polyacrylates, for example poly(meth)acrylate having pendant aromatic rings, or as curing agents for the preparation of thermoset polyesters, namely unsaturated polyesters resins which can be implemented for the manufacture of artificial marble products, gel coats, marine watercraft, polymer concrete and more.

Aromatic peroxides are well known in commerce and can be selected among the aromatic peresters family, namely perbenzoates, such as tertio-butyl peroxybenzoate (denoted TBPB) sold for example under the name Luperox® P, aryl peralkylates and aromatic diperesters, the aryl-alkyl peroxides family, such as dicumyl peroxide, the aryl hydroperoxides family such as cumene hydroperoxide, and the aromatic diacyl peroxides family such as di(2,4-dichloro benzoyl)peroxide.

However, one of the main disadvantages of the aforementioned aromatic peroxides is that they are usually subject to a colour transformation after a certain period of time at room temperature or at recommended storage temperature conditions (i.e. between 8 and 30° C.) under standard storage conditions. In particular, it has been pointed out that the colour of said aromatic peroxides steadily increases or even soars sometimes over a relatively short period of time, for example the colour of tertio-butyl peroxybenzoate can flare up over a period of time of 21 days during their storage. It bespeaks that the aforementioned aromatic peroxides can experience a colour stability issue during their storage, even in the dark.

As a result, this colour stability issue can reduce the time of storage of aromatic peroxides forcing sometimes the manufacturers of the targeted polymer resins to use them earlier than expected before they develop a significant and irreversible colour variation. Indeed, there is a likely risk that said coloured impurities of the aromatic peroxides tint the polymers or polymer resins during their preparations which can turn out to be a relevant issue depending on their designed applications.

Especially, the production of polymers or polymer resins that are unintentionally coloured due to the coloration provided by the aromatic peroxides can easily be misinterpreted by some users as meaning that said polymers or polymer resins are of poor quality. As an example, one can assume that said produced polymers or polymer resins had been subject to photooxidation or photodegradation which altered their natural aspect and properties.

More broadly, the lack of colour stability of said aromatic peroxides during storage may affect the aspect of the targeted polymeric compounds and alter the overall appearance of the final product. It can also lead to a misinterpretation of the quality of said polymeric compounds and the products obtained therefrom.

Moreover, this coloration can render more difficult the manufacture of polymeric compounds which are supposed to have specific light color characteristics imposed by their industrial applications, for instance LDPE blister applications.

Besides, in some cases, this colouration can render more tedious the subsequent addition of dyes designed to impart a specific colour to the final aspect of the polymeric compounds. Indeed, the produced polymeric compounds can exhibit sometimes a colour due to the aromatic peroxides which does not match with the dyes required to be added.

Hence, on a commercial standpoint, the risks of transferring the colour of the aforementioned aromatic peroxides can represent a hurdle to the economic value of the manufactured polymers and polymer resins.

The development of colour in a composition comprising aromatic peroxides might also interfere with the eventual presence of coloured dyes that had been added on purpose into said composition, for example as a visual aid to help the operator during its process.

Accordingly, it remains a real need to provide compositions comprising aromatic peroxides which are able to be colour stable over time under recommended storage conditions in order to mitigate the risks of colour transfer to the targeted polymeric compounds previously detailed.

In particular, one of the goals of the present invention is to minimize the colour development of aromatic peroxides during storage, especially at room temperature, in order to be able to use them efficiently to manufacture said polymeric compounds without negatively impacting their aspect.

More specifically, another goal of the present invention is to curb the increase of colour of aromatic peroxides during their storage period.

### DESCRIPTION OF THE INVENTION

The present invention namely results from the unexpected findings, by the inventors, that the use of at least one ketone peroxide is able to improve the colour stability over time of at least one aromatic peroxide as defined hereinafter (i.e. to curb the evolution of colour of said aromatic peroxides) and also to decrease the colouration due to said aromatic peroxides.

Therefore, the present invention relates to a composition comprising:
a) at least one aromatic peroxide comprising at least one aromatic ring and at least one peroxo —O—O— function in its structure; preferably the aromatic ring is connected to said peroxo function by a covalent bond, a carbonyl group (—C(═O)—)) or an alkyl group comprising from 1 to 20 carbon atoms;
   the aromatic peroxide being present in said composition at a concentration ranging from 30 to 99.9% by weight relative to the total weight of the composition,
b) at least one ketone peroxide, being at a concentration ranging from 0.1 to 30% by weight relative to the total weight of the composition.

The composition of the present invention displays a better colour stability over time under standard storage conditions than a composition comprising only the aforementioned aromatic peroxide(s), especially at room temperature, and especially in the dark.

In more detail, the composition according to the present invention exhibits a significant lower APHA colour value than the same composition comprising only the aforementioned aromatic peroxide(s) over a period of time of at least 5 days, in particular of at least 15 days, especially of at least 20 days, preferably of at least 30 days, more preferably of at least 50 days and even more particularly over at least 90 days, under standard storage conditions, especially at room temperature, and especially in the dark.

According to the present invention, the expression “room temperature” stands for a range of temperatures from 0° ° C. to 50° C., preferably from 10° C. to 40° C., more preferably from 15° C. to 30° C., even more preferably from 20° C. to 30° ° C.

According to the present invention, the expression “in the dark” means that the composition is protected from light, and in particular is protected from ultraviolet (UV) radiations.

According to the present invention, the APHA colour is a colour standard named after the American Public Health Association and defined by the standard ASTM D1209, and more precisely ASTM D1209-05(2011). The APHA colour is a colour scale, sometimes also called “yellow index”, which makes it possible to evaluate the quality of specimens that are pale to yellowish in colour. The APHA colour is measured using a colorimeter with a standard range of from 0 to 1000 APHA.

The colour of the composition according to the present invention can be assessed with a spectral colorimeter such as the one sold under the name LICO 620 by Hach company.

In other words, the addition of at least one ketone peroxide is able to decrease or to stabilize the APHA colour value of the aforementioned aromatic peroxide(s).

The colour stability of the composition of the present invention helps to minimize the risks that there is an unwanted colour occurring from the aromatic peroxides, due to their time of storage, to the targeted polymeric compounds.

As a consequence, the composition of the present invention can efficiently be used for the preparation of polymer, in particular polystyrene, or polymer resins, preferably a polymer ester resin, without altering their aspect, i.e. without unintentionally tinting them.

More precisely, the use of at least one ketone peroxide is able to significantly curb the evolution of colour of aromatic peroxides with time, especially at room temperature.

It also means that the addition of at least one ketone peroxide is able to extend the time of said aromatic peroxides usages in applications, especially at room temperature.

As a consequence, the use of at least one ketone peroxide is able to restore the economic value of the aromatic peroxides since they can be stored under standard conditions for extended period of times without experiencing a significant and inacceptable colour development.

The present invention also relates to a method for the preparation of the aforementioned composition comprising mixing at least one aromatic peroxide, as previously defined, and at least one ketone peroxide.

As mentioned previously, the composition exhibits an enhanced colour stability.

The invention also deals with the use of a composition as previously defined in order to prepare a polymer, preferably styrenic polymers, or a polymer resin, in particular a polymer ester resin, said polymer ester resin being preferably chosen in the group consisting of unsaturated polyester resin, acrylic resin, methacrylic resin and vinyl ester resin, more preferably chosen in the group consisting of unsaturated polyester resin and vinyl ester resin.

In details, the composition of the present invention can be used efficiently for the polymerization reaction of styrenic polymers, vinyl ester resins or poly(meth)acrylates, or as a curing agent for the preparation of thermoset polyesters, namely unsaturated polyesters resins.

Another aspect of the present invention is the use of at least one ketone peroxide to improve the colour stability of at least one aromatic peroxide, in particular at room temperature.

Preferably, one of the aspects of the present invention is to use at least one ketone peroxide in order to curb the evolution of colour of aromatic peroxides.

Other subjects and characteristics, aspects and advantages of the invention will emerge even more clearly on reading the description and the example that follows.

In the text herein below, and unless otherwise indicated, the limits of a range of values are included in that range, in particular in the expressions “between” and “ranging from . . . to . . . ”.

Moreover, the expression “at least one” used in the present description is equivalent to the expression “one or more”.

The term “polymerization” encompasses both homo- and co-polymerization of one or more of the involved unsaturated monomers.

As intended herein, the term “comprising” has the meaning of “including” or “containing”, which means that when an object “comprises” one or several elements, other elements than those mentioned may also be included in the object. In contrast, when an object is said to “consist of” one or several elements, the object is limited to the listed elements and cannot include other elements than those mentioned.

### BRIEF DESCRIPTION OF THE DRAWINGS

FIG. 1 represents the measurements of APHA values versus time for compositions A and B-F illustrated in Table 1 at a temperature of 40° C.

FIG. 2 represents the measurements of APHA values versus time for compositions A1 and B1-G1 illustrated in Table 2 at a temperature of 40° C.

FIG. 3 represents the APHA values versus time for compositions A2 and B2-H2 illustrated in Table 3 measured at 40° C.

### COMPOSITION

As previously detailed, the composition according to the present invention comprises:
a) at least one aromatic peroxide comprising at least one aromatic ring and at least one peroxo —O—O— function in its structure; preferably the aromatic ring is connected to said peroxo function by a covalent bond, a carbonyl group or an alkyl group comprising from 1 to 20 carbon atoms;
   the aromatic peroxide being present in said composition at a concentration ranging from 30 to 99.9% by weight relative to the total weight of the composition,
b) at least one ketone peroxide being at a concentration ranging from 0.1 to 30% by weight relative to the total weight of the composition.

Preferably, the at least one ketone peroxide is chosen among the group consisting of methyl ethyl ketone peroxide and methyl isobutyl ketone peroxide, and combination thereof.

Preferably, the composition of the invention is a curing composition or a composition for initiating a radical polymerization. In other words, the composition of the invention is preferentially devoid of any monomer and/or polymer to be cured and/or polymerized.

### Aromatic Peroxide

The aromatic ring of the aromatic peroxide can be substituted by a linear or branched C₁-C₁₀ alkyl radical, especially C₁-C₄ alkyl radical, and/or one or more halogen atoms, preferably a linear or branched C₁-C₁₀ alkyl radical, especially C₁-C₄ alkyl radical.

Preferably, the aromatic peroxide comprises at least one benzene ring. The benzene ring is preferably connected to the peroxo function by a covalent bond, a carbonyl group or an alkyl group comprising from 1 to 20 carbon atoms, preferably from 1 to 10 carbon atoms, more preferably from 1 to 2 carbon atoms, even more preferably 1 carbon atom.

Preferably, the aromatic peroxide comprises at least one benzene ring and at least one peroxo —O—O— function in its structure; the benzene ring being connected to said peroxo function by no more than two carbon atoms, even more preferably no more than one carbon atom.

According to the present invention, the expression “the benzene ring being connected to said peroxo function by no more than two carbon atoms” means that the benzene ring is connected to —O—O— function of the aromatic peroxide by a covalent bond, a carbonyl group or alkyl group which does not comprise more than two carbon atoms (an alkyl group of two carbon atoms being included).

According to the present invention, the expression “the benzene ring being connected to said peroxo function by no more than one carbon atoms” means that the benzene ring is connected to —O—O— function of the aromatic peroxide by a covalent bond, a carbonyl group or alkyl group which does not comprise more than one carbon atom (one carbon atom being included).

Preferably, the aromatic peroxide comprises at least one benzene ring and at least one peroxo —O—O— function in its structure; the benzene ring being connected to said peroxo function by a covalent bond, a carbonyl group or an alkyl group comprising from 1 to 2 carbon atoms, even more preferably 1 carbon atom; the benzene ring being optionally substituted by a linear or branched C₁-C₁₀ alkyl radical, especially C₁-C₄ alkyl radical, and/or one or more halogen atoms.

Preferably, the aromatic peroxide as defined above is liquid at room temperature.

The aromatic peroxide can be chosen among the group consisting of aromatic peresters, aryl-alkyl peroxides, aryl hydroperoxides, aromatic diacyl peroxides and mixtures thereof.

Preferably, the aromatic peroxide can be chosen among the group consisting of aromatic peresters.

Preferably, the aromatic peroxide comprises at least one benzene ring and at least one peroxo —O—O— function in its structure; the benzene ring being connected to said peroxo function by a covalent bond, a carbonyl group or an alkyl group comprising from 1 to 2 carbon atoms, even more preferably 1 carbon atom; the benzene ring being optionally substituted by a linear or branched C₁-C₄ alkyl radical and/or one or more halogen atoms; and the aromatic being chosen among the group consisting of aromatic peresters, aryl-alkyl peroxides, aryl hydroperoxides, aromatic diacyl peroxides and mixtures thereof; especially aromatic peresters.

The aromatic peroxide selected from aromatic peresters is preferably chosen among the group consisting of perbenzoates, aryl peralkylates, aromatic diperesters and mixtures thereof.

Advantageously, the aromatic peroxide is selected among the group consisting of perbenzoates.

Preferably, the aromatic peroxide has the following formula (I):

R₁—O—O—R₂ (I)
in which
   R₁ represents:
      a —C(═O)R′₁ group, wherein R′₁ denotes an aryl group having from 3 to 30 carbon atoms optionally substituted by a linear or branched C₁-C₁₀ alkyl radical and/or one or more halogen atoms, or
   a linear or branched C₁-C₂₀ alkyl radical terminated with an aryl group having from 3 to 30 carbon atoms optionally substituted by a linear or branched C₁-C₁₀ alkyl radical and/or one or more halogen atoms, or
   a —CR′1 group, wherein R′1 denotes an aryl group having from 6 to 32 carbon atoms optionally substituted by a linear or branched C₁-C₁₀ alkyl radical and/or one or more halogen atoms;
   R₂ represents:
   a linear or branched C₁-C₂₀ alkyl radical,
   an aryl group having from 3 to 30 carbon atoms optionally substituted by a linear or branched C₁-C₁₀ alkyl radical and/or one or more halogen atoms,
   a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes an aryl group having from 3 to 30 carbon atoms optionally substituted by a linear or branched C₁-C₁₀ alkyl radical and/or one or more halogen atoms,
   a linear or branched C₁-C₂₀ alkyl radical terminated with an aryl group having from 3 to 30 carbon atoms optionally substituted by a linear or branched C₁-C₁₀ alkyl radical and/or one or more halogen atoms,
   a —C(—O)R′₂ group, wherein R′₂ denotes an aryl group having from 3 to 30 carbon atoms optionally substituted by a linear or branched C₁-C₁₀ alkyl radical and/or one or more halogen atoms, or
   a hydrogen atom.

Preferably, the aromatic peroxide has the following formula (I):

R₁—O—O—R₂ (I)
in which:
   R₁ represents:
      a —C(═O)R′₁ group, wherein R′₁ denotes a benzene ring optionally substituted by a linear or branched C₁-C₁₀ alkyl radical and/or one or more halogen atoms, preferably chlorine atoms, or
      a linear or branched C₁-C₂₀ alkyl radical terminated with a benzene ring which is optionally substituted by a linear or branched C₁-C₁₀ alkyl radical and/or one or more halogen atoms, preferably chlorine atoms;
   R₂ represents:
      a linear or branched C₁-C₂₀ alkyl radical,
      a benzene ring optionally substituted by a linear or branched C₁-C₁₀ alkyl radical and/or one or more halogen atoms, preferably chlorine atoms,
      a —R₃OOR₄ group, wherein R₃ represents a linear or branched C₈-C₂₀ alkyl radical, preferably C₈-C₁₀ alkyl radical, and R$ represents a —C(═O)R′₄ group in which R′₄ denotes a benzene ring optionally substituted by a linear or branched C₁-C₁₀ alkyl radical and/or one or more halogen atoms,
      a linear or branched C₁-C₂₀ alkyl radical terminated with a benzene ring optionally substituted by a linear or branched C₁-C₁₀ alkyl radical and/or one or more halogen atoms,
      a —C(═O)R′₂ group, wherein R′₂ denotes a benzene ring optionally substituted by a linear or branched C₁-C₁₀ alkyl radical and/or one or more halogen atoms, preferably chlorine atoms,
      a hydrogen atom.

Preferably, R₁ represents:
a —C(═O)R′₁ group, wherein R′₁ denotes a benzene ring optionally substituted by a linear or branched C₁-C₁₀ alkyl radical, preferably C₁-C₄ alkyl radical, and/or one or more halogen atoms, preferably chlorine atoms, or
a linear or branched C₁-C₁₀ alkyl radical, preferably a branched C₁-C₁₀ alkyl radical, which is terminated with a benzene ring which is optionally substituted by a linear or branched C₁-C₁₀ alkyl radical, preferably C₁-C₄ alkyl radical, and/or one or more halogen atoms, preferably chlorine atoms.

Preferably, R₂ represents:
a linear or branched C₁-C₁₀ alkyl radical, especially C₁-C₈ alkyl radical, more preferably a branched C₁-C₅ alkyl radical,
a benzene ring optionally substituted by a linear or branched C₁-C₁₀ alkyl radical, especially a linear or branched C₁-C₄ alkyl radical and/or one or more halogen atoms, preferably chlorine atoms,
a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes a benzene ring optionally substituted by a linear or branched C₁-C₁₀ alkyl radical, especially C₁-C₄ alkyl radical, and/or one or more halogen atoms, preferably chlorine atoms,
a linear or branched C₁-C₁₀ alkyl radical, preferably a branched C₁-C₁₀ alkyl radical, which is terminated with a benzene ring optionally substituted by a linear or branched C₁-C₁₀ alkyl radical, especially C₁-C₄ alkyl radical, and/or one or more halogen atoms, preferably chlorine atoms,
a —C(═O)R′₂ group, wherein R′₂ denotes a benzene ring optionally substituted by a linear or branched C₁-C₁₀ alkyl radical, preferably C₁-C₄ alkyl radical, and/or one or more halogen atoms, preferably chlorine atoms,
a hydrogen atom.

Preferably, in formula (I):
R₁ represents:
   a —C(═O)R′₁ group, wherein R′₁ is a benzene ring optionally substituted by a linear or branched C₁-C₁₀ alkyl radical, preferably C₁-C₄ alkyl radical, and/or one or more halogen atoms, preferably chlorine atoms, or
   a linear or branched C₁-C₁₀ alkyl radical, preferably a branched C₁-C₁₀ alkyl radical, which is terminated with a benzene ring which is optionally substituted by a linear or branched C₁-C₁₀ alkyl radical, preferably C₁-C₄ alkyl radical, and/or one or more halogen atoms, preferably chlorine atoms,
R₂ represents:
   a linear or branched C₁-C₁₀ alkyl radical, especially C₁-C₅ alkyl radical, more preferably a branched C₁-C₈ alkyl radical,
   a benzene ring optionally substituted by a linear or branched C₁-C₁₀ alkyl radical, especially a linear or branched C₁-C₄ alkyl radical and/or one or more halogen atoms, preferably chlorine atoms,
   a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes a benzene ring optionally substituted by a linear or branched C₁-C₁₀ alkyl radical, especially C₁-C₄ alkyl radical, and/or one or more halogen atoms,
   a linear or branched C₁-C₁₀ alkyl radical, preferably a branched C₁-C₁₀ alkyl radical, which is terminated with a benzene ring optionally substituted by a linear or branched C₁-C₁₀ alkyl radical, especially C₁-C₄ alkyl radical, and/or one or more halogen atoms, preferably chlorine atoms,
   a —C(═O)R′₂ group, wherein R′₂ denotes a benzene ring optionally substituted by a linear or branched C₁-C₁₀ alkyl radical, preferably C₁-C₄ alkyl radical, and/or one or more halogen atoms, preferably chlorine atoms,
   a hydrogen atom.

Preferably, the aromatic peroxide has the following formula (I):

R₁—O—O—R₂ (I)
in which:
   R₁ represents:
   a —C(═O)R′₁ group, wherein R′₁ denotes a benzene ring optionally substituted by a linear or branched C₁-C₁₀ alkyl radical, preferably C₁-C₄ alkyl radical, and/or one or more halogen atoms, preferably chlorine atoms,
R₂ represents:
   a linear or branched C₁-C₁₀ alkyl radical, especially C₁-C₈ alkyl radical, more preferably a branched C₁-C₈ alkyl radical,
   a benzene ring optionally substituted by a linear or branched C₁-C₁₀ alkyl radical, especially a linear or branched C₁-C₄ alkyl radical, even more preferably a branched C₁-C₄ alkyl radical, and/or one or more halogen atoms, preferably chlorine atoms,
   a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes a benzene ring optionally substituted by a linear or branched C₁-C₁₀ alkyl radical, especially C₁-C₄ alkyl radical, and/or one or more halogen atoms, preferably chlorine atoms,
   a —C(═O)R′₂ group, wherein R′₂ denotes a benzene ring optionally substituted by a linear or branched C₁-C₁₀ alkyl radical, preferably C₁-C₄ alkyl radical, and/or one or more halogen atoms, preferably chlorine atoms.

Preferably, the aromatic peroxide has the following formula (I):

R₁—O—O—R₂ (I)
in which:
   R₁ represents:
      a —C(═O)R′₁ group, wherein R′₁ denotes a benzene ring optionally substituted by a linear or branched C₁-C₁₀ alkyl radical, preferably C₁-C₄ alkyl radical, and/or one or more halogen atoms, preferably chlorine atoms,
   R₂ represents:
      a linear or branched C₁-C₁₀ alkyl radical, especially C₁-C₈ alkyl radical, more preferably a branched C₁-C₈ alkyl radical.

Preferably, the aromatic peroxide is selected from the group consisting of t-butyl-peroxybenzoate, such as the one sold under the name Luperox® P, cumyl peroxyneoheptanoate, such as the one sold under the name Luperox® 288, cumyl peroxyneodecanoate, such as the one sold under the name Luperox® 188, 2,5-dimethyl-2,5-(dibenzoylperoxy)hexane, such as Luperox® 118, tert-butyl cumyl peroxide, such as the one sold under the name Luperox® 801, dicumyl peroxide, such as the one sold under the name Luperox® DCP, cumene hydroperoxide, such as the one sold under the name Luperox® CU80, di(2,4-dichloro benzoyl)peroxide, such as the one under the name Luperox® DCBP, 1,3 1,4-Bis(tert-butylperoxyisopropyl)benzene, such as the one under the name Luperox® F, tert-amyl peroxybenzoate, such as Luperox® TAP and mixtures thereof.

Preferably, the aromatic peroxide is selected from the group consisting of t-butyl-peroxybenzoate, cumyl peroxyneoheptanoate, cumyl peroxyneodecanoate, 2,5-dimethyl-2,5-(dibenzoylperoxy)hexane, tert-amyl peroxybenzoate, and mixtures thereof.

Advantageously, the aromatic peroxide is t-butyl-peroxybenzoate.

The aromatic peroxide is present in the composition at a concentration ranging from 30 to 99.9%, preferably ranging from 70 to 99.9%, more preferably ranging from 90 to 99.9% by weight relative to the total weight of the composition.

In particular, the aromatic peroxide is t-butyl-peroxybenzoate and is present at a concentration ranging from 30 to 99.9%, preferably ranging from 70 to 99.9%, more preferably ranging from 90 to 99.9% by weight relative to the total weight of the composition.

In a specific embodiment, the composition of the present invention does not comprise other aromatic peroxides than the one as defined above.

### Ketone Peroxide

As intended herein a “ketone peroxide” refers to an organic compound comprising at least one peroxide functional group (—OOH).

Preferably, the ketone peroxide as defined above is liquid at room temperature.

The ketone peroxide is preferably chosen among the group consisting of methyl ethyl ketone peroxide, methyl isobutyl ketone peroxide, 2,4-pentanedione peroxide and mixtures thereof, even more preferably methyl ethyl ketone peroxide and methyl isobutyl ketone peroxide.

Preferably, the ketone peroxide according to the invention is of the following formula (II):

R₃CR₄(OOH)₂ (II)
Wherein R₃ and R₄:
   Independently of each other represents a linear or branched C₁-C₂₀ alkyl radical, or
   form together a cyclic group, substituted or not, preferably a C₄-C₆ cyclic group.

According to a particular embodiment, the ketone peroxide can be in the form of a dimer (having the formula (III) R₃R₄C(OOH)OOC(OOH)R₃R₄, R₃ and R₄ being as defined above) or a trimer (having the formula (IV) R₃R₄C(OOH)OOCR₃R₄OOC(OOH)R₃R₄, R₃ and R₄ being as defined above), preferably a dimer.

Advantageously, the ketone peroxide is chosen among the group consisting of methyl ethyl ketone peroxide, such as the one sold under the name Luperox® K1 and and methyl isobutyl ketone peroxide, such as the one sold under the name Luperox® K2.

The ketone peroxide is present in the composition at a concentration ranging from 0.1 to 30%, especially ranging from 1 to 29%, preferably ranging from 2 to 25%, more preferably 4 to 20%, even more preferably 5 to 10% by weight, relative to the total weight of the composition.

In particular, the ketone peroxide is methyl ethyl ketone peroxide and is present in the composition at a concentration ranging from 0.1 to 30%, especially ranging from 1 to 29%, preferably ranging from 2 to 25%, more preferably 4 to 20%, even more preferably 5 to 10% by weight, relative to the total weight of the composition.

Preferably, the composition according to the present invention comprises:
a) at least one aromatic peroxide having the following formula (I)

R₁—O—O—R₂ (I)
in which:
   R₁ represents:
      a —C(═O)R′₁ group, wherein R′₁ denotes a benzene ring optionally substituted by a linear or branched C₁-C₁₀ alkyl radical and/or one or more halogen atoms, preferably chlorine atoms, or
      a linear or branched C₁-C₂₀ alkyl radical terminated with a benzene ring which is optionally substituted by a linear or branched C₁-C₁₀ alkyl radical and/or one or more halogen atoms, preferably chlorine atoms; or
      a —CR′₁ group, wherein R′₁ denotes an aryl group having from 6 to 32 carbon atoms optionally substituted by a linear or branched C₁-C₁₀ alkyl radical and/or one or more halogen atoms,
   R₂ represents:
      a linear or branched C₁-C₂₀ alkyl radical,
      a benzene ring optionally substituted by a linear or branched C₁-C₁₀ alkyl radical and/or one or more halogen atoms, preferably chlorine atoms,
      a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes a benzene ring optionally substituted by a linear or branched C₁-C₁₀ alkyl radical and/or one or more halogen atoms,
      a linear or branched C₁-C₂₀ alkyl radical terminated with a benzene ring optionally substituted by a linear or branched C₁-C₁₀ alkyl radical and/or one or more halogen atoms,
      a —C(═O)R′₂ group, wherein R′₂ denotes a benzene ring optionally substituted by a linear or branched C₁-C₁₀ alkyl radical and/or one or more halogen atoms, preferably chlorine atoms,
      a hydrogen atom.
the aromatic peroxide being present in said composition at a concentration ranging from 30 to 99.9% by weight relative to the total weight of the composition,
b) at least one ketone peroxide is preferably chosen among the group consisting of methyl ethyl ketone peroxide, methyl isobutyl ketone peroxide, 2,4-pentanedione peroxide and mixtures thereof, preferably methyl ethyl ketone peroxide and methyl isobutyl ketone peroxide, even more preferably methyl ethyl ketone peroxide;
the ketone peroxide being present in said composition at a concentration ranging from 0.1 to 30% by weight relative to the total weight of the composition.

Preferably, the composition according to the present invention comprises:
a) at least one aromatic peroxide having the following formula (I)

R₁—O—O—R₂ (I)
in which:
   R₁ represents:
      a —C(═O)R′₁ group, wherein R′₁ denotes a benzene ring optionally substituted by a linear or branched C₁-C₁₀ alkyl radical, preferably C₁-C₄ alkyl radical, and/or one or more halogen atoms, preferably chlorine atoms,
   R₂ represents:
      a linear or branched C₁-C₁₀ alkyl radical, especially C₁-C₅ alkyl radical, more preferably a branched C₁-C₈ alkyl radical,
      a benzene ring optionally substituted by a linear or branched C₁-C₁₀ alkyl radical, especially a linear or branched C₁-C₄ alkyl radical, even more preferably a branched C₁-C₄ alkyl radical, and/or one or more halogen atoms, preferably chlorine atoms,
      a —R₃OOR₄ group, wherein R₃ represents a linear or branched C₈-C₂₀ alkyl radical, preferably C₈-C₁₀ alkyl radical, and R₄ represents a —C(—O)R′₄ group in which R′₄ denotes a benzene ring optionally substituted by a linear or branched C₁-C₁₀ alkyl radical, especially C₁-C₄ alkyl radical, and/or one or more halogen atoms, preferably chlorine atoms,
      a —C(═O)R′₂ group, wherein R′₂ denotes a benzene ring optionally substituted by a linear or branched C₁-C₁₀ alkyl radical, preferably C₁-C₄ alkyl radical, and/or one or more halogen atoms, preferably chlorine atoms;
the aromatic peroxide being present in said composition at a concentration ranging from 30 to 99.9% by weight relative to the total weight of the composition;
b) at least one ketone peroxide is preferably chosen among the group consisting of methyl ethyl ketone peroxide, methyl isobutyl ketone peroxide, 2,4-pentanedione peroxide and mixtures thereof, preferably methyl ethyl ketone peroxide and methyl isobutyl ketone peroxide, even more preferably methyl ethyl ketone peroxide;
the ketone peroxide being present in said composition at a concentration ranging from 0.1 to 30% by weight relative to the total weight of the composition.

Preferably, the composition according to the present invention comprises:
a) at least one aromatic peroxide selected from the group consisting of t-butyl-peroxybenzoate, cumyl peroxyneoheptanoate, cumyl peroxyneodecanoate, 2,5-dimethyl-2,5-(dibenzoylperoxy)hexane, tert-butyl cumyl peroxide, dicumyl peroxide, cumene hydroperoxide, di(2,4-dichloro benzoyl)peroxide, 1,3 1,4-Bis(tert-butylperoxyisopropyl)benzene, and mixtures thereof, preferably of t-butyl-peroxybenzoate;
the aromatic peroxide being present in said composition at a concentration ranging from 30 to 99.9% by weight relative to the total weight of the composition;
b) at least one ketone peroxide is chosen among the group consisting of methyl ethyl ketone peroxide, methyl isobutyl ketone peroxide, 2,4-pentanedione peroxide and mixtures thereof, preferably methyl ethyl ketone peroxide and methyl isobutyl ketone peroxide, even more preferably methyl ethyl ketone peroxide;
the ketone peroxide being present in said composition at a concentration ranging from 0.1 to 30% by weight relative to the total weight of the composition.

Preferably, the composition according to the present invention comprises:
a) t-butyl-peroxybenzoate being present in said composition at a concentration ranging from 30 to 99.9%, preferably ranging from 70 to 99.9%, more preferably ranging from 90 to 99.9% by weight relative to the total weight of the composition by weight relative to the total weight of the composition;
b) at least one ketone peroxide selected among the group consisting of methyl ethyl ketone peroxide and methyl isobutyl ketone peroxide; the ketone peroxide being present in said composition at a concentration ranging from 0.1 to 30%, especially ranging from 1 to 29%, preferably ranging from 2 to 25%, more preferably 4 to 20%, even more preferably 5 to 10% by weight, relative to the total weight of the composition.

Advantageously, the composition according to the present invention comprises:
a) t-butyl-peroxybenzoate being present in said composition at a concentration ranging from 30 to 99.9% preferably ranging from 90 to 99.9% by weight relative to the total weight of the composition by weight relative to the total weight of the composition;
b) methyl ethyl ketone peroxide being present in said composition at a concentration ranging from 0.1 to 30%, especially ranging from 1 to 29%, preferably ranging from 2 to 25%, more preferably 4 to 20%, even more preferably 5 to 10% by weight, relative to the total weight of the composition.

Alternatively, the composition according to the present invention comprises:
a) t-butyl-peroxybenzoate being present in said composition at a concentration ranging from 30 to 99.9%, preferably ranging from 70 to 99.9%, more preferably ranging from 90 to 99.9% by weight relative to the total weight of the composition by weight relative to the total weight of the composition;
b) methyl isobutyl ketone peroxide being present in said composition at a concentration ranging from 0.1 to 30%, especially ranging from 1 to 29%, preferably ranging from 2 to 25%, more preferably 4 to 20%, even more preferably 5 to 10% by weight, relative to the total weight of the composition.

Preferably, the weight ratio between the ketone peroxide as defined above and the aromatic peroxide as defined above is ranging from 0.001 to 1, preferably from 0.01 to 0.5, more preferably from 0.015 à 0.3 even more preferably from 0.05 to 0.1.

In a specific embodiment, the composition of the present invention does not comprise other ketone peroxides than the ones as defined above.

Hydrogen peroxide (H₂O₂)

Preferably, the composition according to the invention further comprises hydrogen peroxide (H₂O₂).

Hydrogen peroxide may be present in the composition according to the invention at a concentration ranging from 0.0005 to 3%, preferably ranging from 0.001 to 2%, even more preferably 0.01 to 1.5% by weight, even more preferably 0.1 to 1.5% by weight relative to the total weight of the composition.

Preferably, the composition according to the present invention comprises:
a) at least one aromatic peroxide having the following formula (I):

R₁—O—O—R₂ (I)
in which:
   R₁ represents:
      a —C(═O)R′₁ group, wherein R′₁ denotes a benzene ring optionally substituted by a linear or branched C₁-C₁₀ alkyl radical, preferably C₁-C₄ alkyl radical, and/or one or more halogen atoms, preferably chlorine atoms,
   R₂ represents:
      a linear or branched C₁-C₁₀ alkyl radical, especially C₁-C₈ alkyl radical, more preferably a branched C₁-C₈ alkyl radical,
      a benzene ring optionally substituted by a linear or branched C₁-C₁₀ alkyl radical, especially a linear or branched C₁-C₄ alkyl radical, even more preferably a branched C₁-C₄ alkyl radical, and/or one or more halogen atoms, preferably chlorine atoms,
      a —R₃OOR₄ group, wherein R₃ represents a linear or branched C₈-C₂₀ alkyl radical, preferably C₈-C₁₀ alkyl radical, and R₄ represents a —C(═O)R′₄ group in which R′₄ denotes a benzene ring optionally substituted by a linear or branched C₁-C₁₀ alkyl radical, especially C₁-C₄ alkyl radical, and/or one or more halogen atoms, preferably chlorine atoms,
      a —C(═O)R′₂ group, wherein R′₂ denotes a benzene ring optionally substituted by a linear or branched C₁-C₁₀ alkyl radical, preferably C₁-C₄ alkyl radical, and/or one or more halogen atoms, preferably chlorine atoms;
the aromatic peroxide being present in said composition at a concentration ranging from 30 to 99.9% by weight relative to the total weight of the composition;
b) at least one ketone peroxide is preferably chosen among the group consisting of methyl ethyl ketone peroxide, methyl isobutyl ketone peroxide, 2,4-pentanedione peroxide and mixtures thereof, preferably methyl ethyl ketone peroxide and methyl isobutyl ketone peroxide, even more preferably methyl ethyl ketone peroxide;
the ketone peroxide being present in said composition at a concentration ranging from 0.1 to 30% by weight relative to the total weight of the composition;
c) at least hydrogen peroxide which may be present in the composition at a concentration ranging from 0.0005 to 3% by weight relative to the total weight of the composition.

Preferably, the composition according to the present invention comprises:
a) at least one aromatic peroxide selected from the group consisting of t-butyl-peroxybenzoate, cumyl peroxyneoheptanoate, cumyl peroxyneodecanoate, 2,5-dimethyl-2,5-(dibenzoylperoxy)hexane, tert-butyl cumyl peroxide, dicumyl peroxide, cumene hydroperoxide, di(2,4-dichloro benzoyl)peroxide, 1,3 1,4-Bis(tert-butylperoxyisopropyl)benzene, and mixtures thereof, preferably of t-butyl-peroxybenzoate; the aromatic peroxide being present in said composition at a concentration ranging from 30 to 99.9% by weight relative to the total weight of the composition;
b) at least one ketone peroxide is preferably chosen among the group consisting of methyl ethyl ketone peroxide, methyl isobutyl ketone peroxide, 2,4-pentanedione peroxide and mixtures thereof, preferably methyl ethyl ketone peroxide and methyl ethyl ketone peroxide; the ketone peroxide being present in said composition at a concentration ranging from 0.1 to 30% by weight relative to the total weight of the composition;
c) at least hydrogen peroxide which may be present in the composition at a concentration ranging from 0.0005 to 3% by weight relative to the total weight of the composition.

Preferably, the composition according to the present invention comprises:
a) at least one aromatic peroxide selected from the group consisting of t-butyl-peroxybenzoate, cumyl peroxyneoheptanoate, cumyl peroxyneodecanoate, 2,5-dimethyl-2,5-(dibenzoylperoxy)hexane, and mixtures thereof, preferably of t-butyl-peroxybenzoate; the aromatic peroxide being present in said composition at a concentration ranging from 30 to 99.9% by weight relative to the total weight of the composition,
b) at least one ketone peroxide is preferably chosen among the group consisting of methyl ethyl ketone peroxide, methyl isobutyl ketone peroxide, 2,4-pentanedione peroxide and mixtures thereof, preferably methyl ethyl ketone peroxide and methyl ethyl ketone peroxide, more preferably methyl ethyl ketone peroxide; the ketone peroxide being present in said composition at a concentration ranging from 0.1 to 30% by weight relative to the total weight of the composition;
c) at least hydrogen peroxide which may be present in the composition at a concentration ranging from 0.0005 to 3% by weight relative to the total weight of the composition.

### Solvent

The composition may further comprise at least one solvent. The solvent according to the invention can be of any type known to one of skill in the art suitable for solvating organic peroxides, especially aromatic peroxides and ketone peroxide.

In particular, the presence of a solvent can help to promote the homogeneity of the composition of the present invention.

Preferably, the solvent according to the invention is an organic solvent selected from the group consisting of a ketone solvent, an aryl solvent, an ether solvent, an alcohol solvent, a mineral oil and a hydrocarbon solvent.

More preferably, the solvent is selected from the group consisting of dimethyl phthalate, dimethyl terephthalate, methyl isobutyl ketone, cyclohexanone, ethyl acetate, isododecane, glycol ether, ethylene glycol, isopropanol or a combination thereof. More preferably, the solvent is isopropanol.

In the meaning of the present invention, it is understood that the glycol ether is different from an additive having an ether group as defined below.

### Additives

The composition of the invention may comprise one or more additives.

Preferably the additive is a compound having an ether group, preferably is a compound having the following formula (V) or (VI):

R₁—(O—C₂H₄)ₙ—O—R₂ (V)

Or

R₁—(O—CH₂—CH(CH₃))ₙ—O—R₂ (VI)
Wherein:
   n represents an integer ranging from 1 to 8,
   R₁ and R₂ represent, independently of each other:
      a hydrogen atom, or
      a linear or branched alkyl C₁-C₈ alkyl radical, substituted or not, or
      R₁ and R₂ forming together an ether crown, said ether crown preferably having from 4 to 8 ethylene oxyde groups, more preferably having from 4 to 5 ethylene oxyde groups, and even more preferably having 5 ethylene oxyde groups.

Preferably, R₁ represents a hydrogen group or a methyl group, more preferably an hydrogen group.

Preferably, R₂ represents a linear or branched alkyl C₁-C₈ alkyl radical, substituted or not, more preferably represents a linear C₁-C₈ alkyl radical, more preferably a C₂ alkyl radical.

Preferably, n represents an integer ranging from 1 to 3, more preferably is equal to 2.

Preferably, R₁ represents a hydrogen group or a methyl group, more preferably an hydrogen group and R₂ represents a linear or branched alkyl C₁-C₈ alkyl radical, substituted or not, more preferably represents a linear C₁-C₈ alkyl radical, more preferably a C₂ alkyl radical.

Preferably, R₁ represents a hydrogen group or a methyl group, more preferably an hydrogen group, R₂ represents a linear or branched alkyl C₁-C₈ alkyl radical, substituted or not, more preferably represents a linear C₁-C₈ alkyl radical, more preferably a C₂ alkyl radical and n represents an integer ranging from 1 to 3, more preferably is equal to 2.

Preferably, the compound having an ether group has the formula (V) as defined above.

Preferably, the compound having an ether group is chosen in the group consisting of a di(ethylene glycol) ethyl ether (EDGE), di(ethylene glycol) ethyl methyl ether (DEGMEE), 1,4,7,10,13-pentaoxycyclopentadecane, di(propylene glycol) ethyl ether, di(propylene glycol) ethyl methyl ether and mixture thereof, more preferably is chosen in the group consisting of a di(ethylene glycol) ethyl ether, di(ethylene glycol) ethyl methyl ether and mixture thereof, and even more preferably is di(ethylene glycol) ethyl ether.

Preferably, the compound having an ether group is present at a concentration ranging from 0.1% to 20% by weight relative to the total weight of the composition.

Preferably, the composition according to the present invention displays a APHA colour value lower or equal to 200, preferably 150, more preferably 100 over a period of time of at least 5 days, in particular of at least 15 days, especially of at least 20 days, preferably of at least 30 days, more preferably of at least 50 days and even more particularly over at least 90 days, especially at room temperature, preferably in the dark.

### Preparation of the Composition

The present invention also deals with a method for the preparation of the aforementioned composition comprising mixing at least one aromatic peroxide, as previously defined, and at least one ketone peroxide as previously defined.

Preferably, the at least aromatic peroxide, as previously defined, and the one ketone peroxide as previously defined can be blended and stirred by any methods known by the one skilled in the art.

The obtained composition displays the advantage of being colour stable over time.

### Use of the Composition

Another object of the present invention concerns the use of the aforementioned composition in order to prepare a polymer, preferably styrenic polymers, or a polymer resin, in particular a polymer ester resin, said polymer ester resin being preferably chosen in the group consisting of unsaturated polyester resin, acrylic resin, methacrylic resin and vinyl ester resin, more preferably chosen in the group consisting of unsaturated polyester resin and vinyl ester resin.

Preferably, styrenic polymers are selected among the group consisting of polystyrene, high-impact polystyrene (HIPS), acrylonitrile-butadiene-styrene (ABS) copolymers, acrylonitrile-styrene acrylate (ASA) copolymers, styrene acrylonitrile (SAN) copolymers, SAN modified by elastomers, methacrylate-butadiene-styrene (MBS) copolymers, styrene-butadiene copolymers, styrene-butadiene-styrene block (SBS) copolymers and their partially or fully hydrogenated derivatives, styrene-isoprene copolymers, styrene-isoprene-styrene (SIS) block copolymers and their partially or fully hydrogenated derivatives, and styrene-(meth)acrylate copolymers such as styrene-methyl methacrylate copolymers (S/MMA).

Preferably, styrenic polymers are selected among the group consisting of polystyrene, acrylonitrile-butadiene-styrene (ABS) copolymers and styrene acrylonitrile (SAN) copolymers.

As intended herein, the expression “polymer resin” refers to a polymer in association or not with a reactive monomer.

As intended herein, the expression “polymer ester resin” refers to a polymer comprising repetitive ester units in association or not with a reactive monomer.

Preferably, the polymer resin is selected from the group consisting of a polymer ester resin, in particular unsaturated polyester resin, acrylic resin, methacrylic resin and a vinyl ester resin. More preferably, the polymer ester resin is chosen in the group consisting of unsaturated polyester resin and vinyl ester resin, and even more preferably, the polymer resin is an unsaturated polyester resin.

Methods for the synthesis of a polymer resin are well known to one of skill in the art.

Preferably, the polymer is dissolved in a reactive monomer composition, i.e. a composition which comprises the reactive monomer. Preferably, said reactive monomer according to the invention may react with the polymer according to the invention by a copolymerisation reaction.

Preferably, the reactive monomer is selected from the group consisting of a vinylic compound, an acrylic compound and an allylic compound.

By way of example of a vinylic compound which can be used according to the invention, it is possible to cite a styrene compound, such as styrene, methylstyrene, p-chlorostyrene, t-butylstyrene, divinylbenzene or bromostyrene, vinylnaphthalene, divinylnaphtalene, vinylacetate, vinylpropionate, vinylpivalate, vinylether and divinylether.

By way of example of an acrylic compound which can be used according to the invention, it is possible to cite methylacrylate, ethylacrylate, propylacrylate, isopropylacrylate, butylacrylate, isobutylacrylate, phenylacrylate, and benzylacrylate.

By way of example of an allyl compound which can be used according to the invention, it is possible to cite allylphthalate, diallylphthalate, diallylisophthalate, triallylcyanurate and diallylterephthalate.

Preferably, the polymer of the unsaturated polyester resin according to the invention is obtainable by condensation of one or more acid monomers and/or one or more acid anhydride monomers with one or more polyol monomers provided that at least one of the component comprises an ethylenic unsaturation. More preferably, the unsaturated polyester resin according to the invention is obtained by condensation of one more polycarboxylic acid monomers and/or one or more polycarboxylic acid anhydride monomers and one or more glycol monomers, provided that at least one of the component comprises an ethylenic unsaturation.

Preferably, the polymer of the vinyl ester resin according to the invention is obtainable by condensation of one or more poly-epoxide resin with one or more monocarboxylic acid monomer having an ethylenic unsaturation.

The acid monomer according to the invention can be of any type known to one of skill in the art. However, the acid monomer according to the invention is preferably selected from the group consisting of phthalic acid, maleic acid, oxalic acid, malonic acid, isophthalic acid, tetrahydrophthalic acid, hexahydrophthalic acid, succinic acid, sebacic acid, azelaic acid, adipic acid and fumaric acid.

The monocarboxylic acid monomer according to the invention can be of any type known to one of skill in the art. Preferably, the monocarboxylic acid monomer according to the invention is selected from the group consisting of acrylic acid such as methacrylic acid, ethylacrylic acid, propylacrylic acid, isopropylacrylic acid, butylacrylic acid, isobutylacrylic acid, phenylacrylic acid, benzylacrylic acid, halogenated acrylic acid, and cinnamic acid.

The acid anhydride monomer according to the invention can be of any type known to one of skill in the art. Preferably, the acid anhydride monomer according to the invention is selected from the group consisting of phthalic anhydride, maleic anhydride, oxalic anhydride, malonic anhydride, isophthalic anhydride, tetrahydrophthalic anhydride, hexahydrophthalic anhydride, succinic anhydride, sebacic anhydride, azelaic anhydride, adipic anhydride and fumaric anhydride.

The polyol according to the invention can be of any type known to one of skill in the art. Preferably, the polyol according to the invention is a glycol selected from the group consisting of an aliphatic diol and an aromatic diol. More preferably, the polyol according to the invention is selected from the group consisting of ethylene glycol, propylene glycol, diethylene glycol, dipropylene glycol, triethylene glycol, tripropylene glycol, pentylene glycol, hexylene glycol and neopentylene glycol.

The polyepoxide resin according to the invention can be of any type known to one of skill in the art. The poly-epoxide resin according to the invention is preferably selected from the group consisting of glycidyl polyethers of polyhydric alcohols and glycidyl polyethers of polyhydric phenols.

Preferably, the polymer resin, in particular the polymer ester resin, preferably selected in the group consisting of unsaturated polyester resin acrylic resin, methacrylic resin and vinyl ester resin, according to the invention is a thermosetting resin.

The polymer of the invention can comprise a reinforcement material, preferably selected from the group consisting of: glass fibers, carbon fibers, nylon fibers and natural fibers.

In particular, the polymer can be a polyurethane-polyacrylate composition, which is mixed with a reinforcement material, preferably selected from the group consisting of: glass fibers, carbon fibers, nylon fibers and natural fibers. In particular, the invention pertains to the use of the composition as previously defined as a curing agent for the preparation of a polymer resin, preferably a polymer ester resin or as radical initiator for the polymerization of unsaturated monomers, preferably unsaturated based styrene monomers.

According to the present invention, the term “polymerization” also encompasses the feature “copolymerization”.

The polymer resin, in particular the polymer ester resin, preferably chosen in the group consisting of unsaturated polyester resin acrylic resin, methacrylic resin and vinyl ester resin, according to the invention is preferably curable by addition of the composition according to the invention as a curing agent under a temperature allowing the curing reaction.

### Use of Ketone Peroxide

Another aspect of the present invention is directed to the use of at least one ketone peroxide, as previously defined, to improve the colour stability of at least one aromatic peroxide, as previously defined, in particular at a temperature ranging from 15° C. to 30° C., especially from 20° C. to 30° C., and preferentially in the dark.

In addition, the invention concerns the use of at least one ketone peroxide, as previously defined, to decrease APHA value of at least one aromatic peroxide, as previously defined, in particular at a temperature ranging from 15° C. to 30° C., especially from 20° ° C. to 30° C.

Preferably, the weight ratio between the ketone peroxide as defined above and the aromatic peroxide as defined above is ranging from 0.001 to 1, preferably from 0.01 to 0.5, more preferably from 0.015 à 0.3 even more preferably from 0.05 to 0.1.

### Polymer Resin Composition

The present invention also relates to a polymer resin composition comprising:
at least one composition as defined above,
at least one polymer resin as previously disclosed, preferably selected from the group consisting of unsaturated polyester resins.

The examples below are given as illustrations of the present invention.

### EXAMPLES

### Example 1

### I. Tested Organic Peroxides

The organic peroxides implemented in the experimental protocol described hereafter are listed below:
Tert-butyl peroxybenzoate sold under the name Luperox® P,
Methyl ethyl ketone peroxide sold under the name Luperox® K2
Methyl isobutyl ketone peroxide sold under the name Luperox® DDM-C

### II. Tested Composition

In Tables 1 and 2, compositions A and A1 correspond to the blank product Luperox® P sold by Arkema. Compositions B-F and B1-G1 have been prepared at the same time with the ingredients listed hereafter.

The contents are expressed in weight percentage relative to the total weight of the composition.

TABLE 1
Compositions A and B-F

| Compositions | A | B | C | D | E | F |
|---|---|---|---|---|---|---|
| Luperox ® P | 100 | 94 | 92 | 90 | 88 | 80 |
| Luperox ® K2 | — | 6 | 8 | 10 | 12 | 20 |

TABLE 2
Compositions A1 and B1-G1

| Compositions | A1 | B1 | C1 | D1 | E1 | F1 | G1 |
|---|---|---|---|---|---|---|---|
| Luperox ® P | 100 | 96 | 94 | 92 | 90 | 88 | 80 |
| Luperox ® DDM-C | — | 4 | 6 | 8 | 10 | 12 | 20 |

### III. Experimental Protocol

The colour stability of each composition disclosed in Tables 1 and 2, and stored in the dark in a closed tube, has been assessed with the spectral colorimeter sold under the name LICO 620, from Hach company at a temperature of 40° C.

The APHA colour values have been determined for each composition over a period of time of 90 days.

The results for compositions A and B-F have been plotted in Figure land the results for compositions A1 and B1-G1 have been plotted in FIG. 2.

### IV. Results

### 4.1. Results—Compositions A and B-F

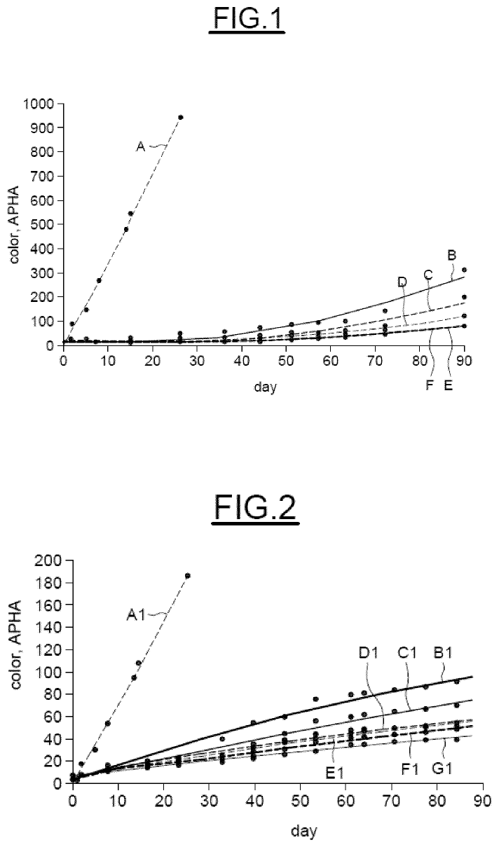

FIG. 1 represents the measurements of APHA values versus time for compositions A and B-F illustrated in Table 1 at a temperature of 40° C.

The results show that the APHA values measured at a temperature of 40° C. for compositions B-F are lower than the ones measured for composition A comprising only tert-butyl peroxybenzoate.

In particular, the results detailed in FIG. 1 outline a spike in the coloration of composition A corresponding to the blank Luperox® P product over a period of time of less than 25 days compared to compositions B-F.

The results also show that the colour increase of compositions B-F comprising a mixture of aromatic peroxide and ketone peroxide at a temperature of 40° C. is significantly lower than the one of composition A comprising only tert-butyl peroxybenzoate.

Hence the results substantiate that the composition according to the present invention has a better colour stability over time than a composition comprising only the aromatic peroxide.

The results also pinpoint that the addition of ketone peroxide leads to the decrease of the APHA values of tert-butyl peroxybenzoate at a temperature of 40° C.

### 4.2. Results—Compositions A1 and B1-G1

FIG. 2 represents the measurements of APHA values versus time for compositions A1 and B1-G1 illustrated in Table 2 at a temperature of 40° C.

The results show that compositions B1 to G1 which comprise a mixture of aromatic peroxide and ketone peroxide exhibit a better colour stability than composition A1 which only comprises tert-butyl peroxybenzoate at a temperature of 40° C.

Indeed, the results demonstrate that the APHA values measured at a temperature of 40° C. regarding compositions B1 to G1 are lower than the APHA values measured for composition A1 comprising only tert-butyl peroxybenzoate.

The results substantiate that the compositions according to the present invention have a better colour stability than a composition comprising only the aromatic peroxide over time.

The results also pinpoint that the addition of ketone peroxide leads to the decrease of the APHA values of tert-butyl peroxybenzoate at a temperature of 40° C.

### Example 2

In the following example, the colour evolution of a Luperox® P product, which had been priorly stored in the dark for a period of time of 21 days, has been closely monitored after the addition of ketone peroxide at several weight concentrations at room temperature.

### I. Experimental Protocol

First, a fresh product Luperox® P sold by Arkema has been made available for assessing its colour at room temperature with a spectral colorimeter sold under the name LICO 620 from Hatch company. It has been observed that the colour of this product is 30 APHA.

This product has then been stored at 40ºC for a period of time of 90 days in the dark in a closed tube, under standard conditions, i.e. the product has not been stirred or moved during this period.

After this period of time, the colour of this product has been once again measured with the aforementioned spectral colorimeter and the development of a yellowish colour has been observed. Indeed, this colour evolution is underpinned by the fact that the APHA value of Luperox® P is higher than 500.

Afterwards, ketone peroxide has been added to the Luperox® P product at several concentrations (2%, 4%, 6%, 8%, 10%, 12% and 20% by weight). In each case, the resulted mixture has then been stored for another period of 21 days at 25° C.

The resulted compositions have been listed in Table 3 below.

TABLE 3
Compositions A2-H2

| Compositions | A2 | B2 | C2 | D2 | E2 | F2 | G2 | H2 |
|---|---|---|---|---|---|---|---|---|
| Luperox ® P | 100 | 98 | 96 | 94 | 92 | 90 | 88 | 80 |
| Luperox ® K2 | — | 2 | 4 | 6 | 8 | 10 | 12 | 20 |

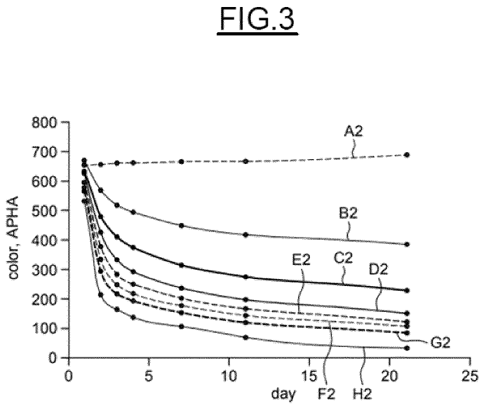

The colour evolution of each composition over time has been plotted in FIG. 3.

### II. Results

FIG. 3 represents the APHA values versus time measured at 40° C.

One can observe that the addition of ketone peroxide leads to the decrease of the APHA values over time of tert-butyl peroxybenzoate at room temperature.

It bespeaks that the addition of ketone peroxide efficiently decreases the yellowish colour of a Luperox® P product which had been priorly stored for a period of time of 90 days.

In particular, the coloration of the Luperox® P decreases with the uptake of concentration of ketone peroxide.

1-18. (canceled)

19. Composition comprising:
a) at least one aromatic peroxide comprising at least one aromatic ring and at least one peroxo —O—O— function in its structure; wherein the aromatic peroxide is present in said composition at a concentration ranging from 30 to 99.9% by weight relative to the total weight of the composition;
b) at least one ketone peroxide, selected from the group consisting of methyl ethyl ketone peroxide and methyl isobutyl ketone peroxide, and combinations thereof, wherein said at least one ketone peroxide is at a concentration ranging from 0.1 to 30% by weight relative to the total weight of the composition.

20. Composition according to claim 19, characterized in that said aromatic peroxide comprises at least one benzene ring.

21. Composition according to claim 19, characterized in that said aromatic peroxide is selected from the group consisting of aromatic peresters, aryl-alkyl peroxides, aryl hydroperoxides, aromatic diacyl peroxides and mixtures thereof.

22. Composition according to claim 21, characterized in that said aromatic peresters are selected from the group consisting of perbenzoates, aryl peralkylates, aromatic diperesters and mixtures thereof.

23. Composition according to claim 19, characterized in that said aromatic peroxide has the following formula (I):
R₁—O—O—R₂ (I)
in which:
R₁ represents:
a —C(═O)R′₁ group, wherein R′₁ denotes an aryl group having from 6 to 32 carbon atoms optionally substituted by a linear or branched C₁-C₁₀ alkyl radical and/or one or more halogen atoms, or
a linear or branched C₁-C₂₀ alkyl radical terminated with an aryl group having from 6 to 32 carbon atoms optionally substituted by a linear or branched C₁-C₁₀ alkyl radical, optionally substituted by a peroxy group, and/or one or more halogen atoms; or
a —CR′₁ group, wherein R′₁ denotes an aryl group having from 6 to 32 carbon atoms optionally substituted by a linear or branched C₁-C₁₀ alkyl radical and/or one or more halogen atoms,
R₂ represents:
a linear or branched C₁-C₂₀ alkyl radical,
an aryl group having from 6 to 32 carbon atoms optionally substituted by a linear or branched C₁-C₁₀ alkyl radical and/or one or more halogen atoms,
a —R₃OOR₄ group, wherein R₃ represents a linear or branched C₈-C₂₀ alkyl radical, and R₄ represents a —C(═O)R′₄ group in which R′₄ denotes an aryl group having from 6 to 32 carbon atoms optionally substituted by a linear or branched C₁-C₁₀ alkyl radical and/or one or more halogen atoms,
a linear or branched C₁-C₂₀ alkyl radical terminated with an aryl group having from 6 to 32 carbon atoms optionally substituted by a linear or branched C₁-C₁₀ alkyl radical and/or one or more halogen atoms,
a —C(═O)R′₂ group, wherein R′₂ denotes an aryl group having from 6 to 32 carbon atoms optionally substituted by a linear or branched C₁-C₁₀ alkyl radical and/or one or more halogen atoms, or
a hydrogen atom.

24. Composition according to claim 23, characterized in that, in formula (I):
R₁ represents:
a —C(═O)R′₁ group, wherein R′₁ denotes a benzene ring optionally substituted by a linear or branched C₁-C₁₀ alkyl radical, and/or one or more halogen atoms, or
a linear or branched C₁-C₁₀ alkyl radical, and/or one or more halogen atoms,
R₂ represents:
a linear or branched C₁-C₁₀ alkyl radical,
a benzene ring optionally substituted by a linear or branched C₁-C₁₀ alkyl radical, especially a linear or branched C₁-C₄ alkyl radical and/or one or more halogen atoms,
a —R₃OOR₄ group, wherein R₃ represents a linear or branched C₈-C₂₀ alkyl radical, and R₄ represents a —C(═O)R′₄ group in which R′₄ denotes a benzene ring optionally substituted by a linear or branched C₁-C₁₀ alkyl radical, especially C₁-C₄ alkyl radical, and/or one or more halogen atoms,
a linear or branched C₁-C₁₀ alkyl radical, and/or one or more halogen atoms,
a —C(═O)R′₂ group, wherein R′₂ denotes a benzene ring optionally substituted by a linear or branched C₁-C₁₀ alkyl radical, and/or one or more halogen atoms,
a hydrogen atom.

25. Composition according to claim 19, wherein the aromatic peroxide is selected from the group consisting of t-butyl-peroxybenzoate, cumyl peroxyneoheptanoate, cumyl peroxyneodecanoate, 2,5-dimethyl-2,5-(dibenzoylperoxy)hexane, tert-butyl cumyl peroxide, dicumyl peroxide, cumene hydroperoxide, di(2,4-dichloro benzoyl)peroxide 1,3 1,4-Bis(tert-butylperoxyisopropyl)benzene, and mixtures thereof.

26. Composition according to claim 19 characterized in that the weight ratio between the ketone peroxide and the aromatic peroxide is ranging from 0.001 to 1.

27. Composition according to claim 19, characterized in that the aromatic peroxide is t-butyl-peroxybenzoate and in that ketone peroxide is selected from the group consisting of methyl ethyl ketone peroxide, methyl isobutyl ketone peroxide and mixtures thereof.

28. Composition according to claim 19, characterized in that it further comprises hydrogen peroxide.

29. Composition according to claim 19, further comprising at least one compound having an ether group, having the following formula (V) or (VI):
R₁—(O—C₂H₄)ₙ—O—R₂ (V)
or
R₁—(O—CH₂—CH(CH₃))n-O—R₂ (VI)
Wherein:
n represents an integer ranging from 1 to 8,
R₁ and R₂ represent, independently of each other:
a hydrogen atom, or
a linear or branched alkyl C₁-C₈ alkyl radical, substituted or not, or
R₁ and R₂ forming together an ether crown, said ether crown.

30. Composition according to claim 19, comprising at least one solvent which is an organic solvent selected from the group consisting of a ketone solvent, an aryl solvent, an ether solvent, an alcohol solvent, a mineral oil and a hydrocarbon solvent.

31. A method for the preparation of the composition as defined according to claim 19, comprising mixing at least one aromatic peroxide, as defined according to claim 19, and at least one ketone peroxide as defined according to claim 19.

32. A method for preparing a polymer or a polymer resin comprising using the composition as defined according to claim 19.

33. The method of claim 32, wherein the composition of claim 19 is used as a curing agent for the preparation of a polymer resin.

34. The method of claim 32, wherein the composition of claim 19 is used as radical initiator for the polymerization of unsaturated monomers.

35. A method of improving the colour stability or decreasing APHA value of the at least one aromatic peroxide as defined according to claim 19 comprising mixing it with at least one ketone peroxide, wherein the at least one ketone peroxide is selected from the group consisting of methyl ethyl ketone peroxide, methyl isobutyl ketone peroxide, and combinations thereof.

36. A polymer resin composition comprising:
at least one composition as defined in claim 19, and
at least one polymer resin.
